(19) United States
(12) Patent Application Publication
(10) Pub. No.: US 2015/0244904 A1
(43) Pub. Date: Aug. 27, 2015

(54) LENS WITH COMBINED BARREL AND HOLDER

(71) Applicant: Genius Electronic Optical Co., Ltd., Taichung City (TW)

(72) Inventors: Matthew Bone, Fremont, CA (US); Melvin Francis, Denver, CO (US)

(21) Appl. No.: 14/571,165

(22) Filed: Dec. 15, 2014

Related U.S. Application Data
(60) Provisional application No. 61/945,717, filed on Feb. 27, 2014.

(51) Int. Cl. H04N 5/225; G02B 13/00; G03B 13/32

(52) U.S. Cl. CPC H04N 5/2252; G03B 13/32; G02B 13/0015; H04N 5/2254; H04N 5/2257

(57) ABSTRACT

A method of manufacturing a compact optical lens module includes providing a housing unit including a lens group, providing a substrate including an image sensor, and inserting a fitting member between the housing unit and the substrate to adjust a focal length of the compact optical lens assembly.

### CROSS-REFERENCES TO RELATED APPLICATIONS

The present application claim priority to U.S. Provisional Patent Application No. 61/945,717, filed Feb. 27, 2014, which is commonly owned and hereby incorporated by reference for all purposes.

### TECHNICAL FIELD

The present disclosure relates to a camera lens apparatus, and more particularly to a camera lens apparatus having a barrel and a holder formed in a single housing unit.

### BACKGROUND OF THE INVENTION

In recent years, an increasing number of portable electronic devices such as tablet computers, PDAs, mobile telephones, and the like have incorporated a compact digital camera. Compact digital cameras are fragile and difficult to manufacture because of their miniature size. A compact camera assembly includes a group of lens elements that is mounted in a lens barrel. The lens barrel is coupled to a holder, which is then connected to a substrate containing an image sensor.

FIG. 1 shows a conventional camera assembly 100 that includes a threaded lens barrel 102 held within a threaded holder 104. The threading allows lens barrel 102 and holder 104 to be moved relative to each other along an optical axis to obtain a desired back focal length during assembly of camera assembly 100. A tight tolerance between the threaded barrel and the threaded holder is required, which makes the assembly of a camera complex and costly. Furthermore, the requirement for a threaded barrel and holder can limit the ability to miniaturize the camera assembly. Another problem of the conventional camera assembly is that particles (fine powders) may be formed when the threaded barrel is screwed into the threaded holder, due to abrasion of the external thread surface of the barrel against the internal surface of the thread surface of the holder. Such particles may affect the quality of the camera assembly.

### SUMMARY OF THE INVENTION

Certain embodiments of the present invention relate to methods of manufacturing a compact optical lens module in which the lens barrel and holder are integrated into a single housing unit. In one embodiment, a method includes providing a housing unit having a lens group, providing a substrate having an image sensor mounted thereon, and inserting a fitting member and an adhesive between the housing unit and the substrate to adjust a focal length of the optical lens module.

In another embodiment, a method of manufacturing a compact optical lens module includes providing a plurality of housing units each having a measured value of a dimension, providing a plurality of lens groups, measuring an optical attribute of each of the lens groups, and assembling a first lens group having a first measurement of the optical attribute within a housing unit having a first measured value of the dimension to obtain a lens assembly having a predetermined optical specification.

Embodiments of the present invention also provide a compact optical imaging lens modules includes a housing unit having a base, a lens group disposed and held with the housing unit, a substrate including an image sensor, and a fitting member and an adhesive disposed between the base of the housing unit and a surface of the substrate.

In an embodiment, the adhesive is a solid material for securing adhesion of the housing unit, the fitting member, and the substrate. As an example, the compact optical imaging lens can include a fitting member that is a solid adhesive for securing adhesion between the housing unit and the substrate.

In an embodiment, the housing unit includes at least two gates for injection molding.

In an embodiment, the fitting member has an opening in relation to the image sensor so that light through the housing unit irradiates the image sensor.

In an embodiment, the fitting member comprises a plurality of slices. Each of the slices has a same thickness.

In an embodiment, the fitting member has a protruding portion and the base of the housing unit has a recessed portion, the recessed portion being configured to receive the protruding portion. The base is substantially planar.

In an embodiment, the fitting member has multiple protruding portions and the base of the housing unit has multiple recessed portions, each of the recessed portions is configured to receive a corresponding one of the protruding portions.

In an embodiment, the optical imaging lens module further includes a positioning member disposed on the surface of the substrate and configured to align the fitting member with the housing unit.

In another embodiment, a method of manufacturing a compact optical imaging lens module includes, for each of a plurality of lens positions in a lens group, providing a plurality of lenses formed by injection molding using at least two lens-shaped mold cavities, and sorting the plurality of lenses into one or more lens classes based on a measurement of an optical characteristic of at least one lens produced by each of the mold cavities. For at least one of the lens positions, the lenses are sorted into at least two lens classes. The method further includes providing a plurality of housing units sorted into a plurality of housing unit classes based on a measurement of a physical dimension of the housing units, selecting a first lens group based on selecting a lens class for each of the plurality of lens positions. The first lens group has a predicted optical attribute. The method also includes selecting a first housing unit from one of the housing unit classes, the housing unit class being selected based on the predicted optical attribute of the first lens group, and assembling the first lens group within the first housing unit.

In one embodiment, the predicted optical attribute is a back focal length. In another embodiment, the predicted optical attribute is an effective focal length.

In an embodiment, the optical characteristic is a focal length.

In an embodiment, the at least two lens-shaped mold cavities have substantially a same size.

In an embodiment, the predicted optical attribute is predicted based on the measured optical characteristics of the selected lens classes.

In an embodiment, the physical dimension is a thickness of a holder of the housing unit.

Embodiments described herein can improve the robustness and reduce the manufacturing cost of a compact digital camera while maintaining the effective focal length or back focal length of the camera assembly within an acceptable tolerance budget. Furthermore, when the barrel and the body are formed in a single housing unit, there is thus, no particles (powders) caused by abrasion of the external surface of the barrel against the internal surface of the body, and the image quality of the camera assembly is improved.

The following description, together with the accompanying drawings, will provide a better understanding of the nature and advantages of the claimed invention.

### BRIEF DESCRIPTION OF THE DRAWINGS

FIG. 1 is a simplified cross-sectional view of a camera lens system according to the prior art.

FIG. 2 is a simplified cross-sectional view of the camera lens system according to an embodiment of the present invention.

FIG. 3A is a simplified cross-sectional view of the camera lens system according to an embodiment of the present invention.

FIG. 3B is a front view of the camera lens system of FIG. 3A.

FIG. 4A is a simplified cross-sectional view of the camera lens system according to an embodiment of the present invention.

FIG. 4B is a top view of a fitting member according to an embodiment of the present invention.

FIG. 5A is a perspective view of a fitting member according to another embodiment of the present invention.

FIG. 5B is a top view of the fitting member of FIG. 5A.

FIG. 5C is a cross-sectional view of a camera lens system including a cross-sectional view of the fitting member cut along line A-A of FIG. 5B.

FIG. 6A is a simplified cross-sectional view of the camera lens system according to another embodiment of the present invention.

FIG. 6B is a plan view of a mold for forming lenses according to one embodiment of the present invention.

FIG. 6C is a simplified cross-sectional view of the camera lens system matched to plan views of molds for forming lenses.

FIG. 7 is a flow chart illustrating a method of manufacturing a compact optical lens assembly according to an embodiment of the present invention.

FIG. 8 is a flow chart illustrating another method of manufacturing a compact optical lens assembly according to an embodiment of the present invention.

FIG. 9 is a flow chart illustrating another method of manufacturing a compact optical lens assembly according to an embodiment of the present invention.

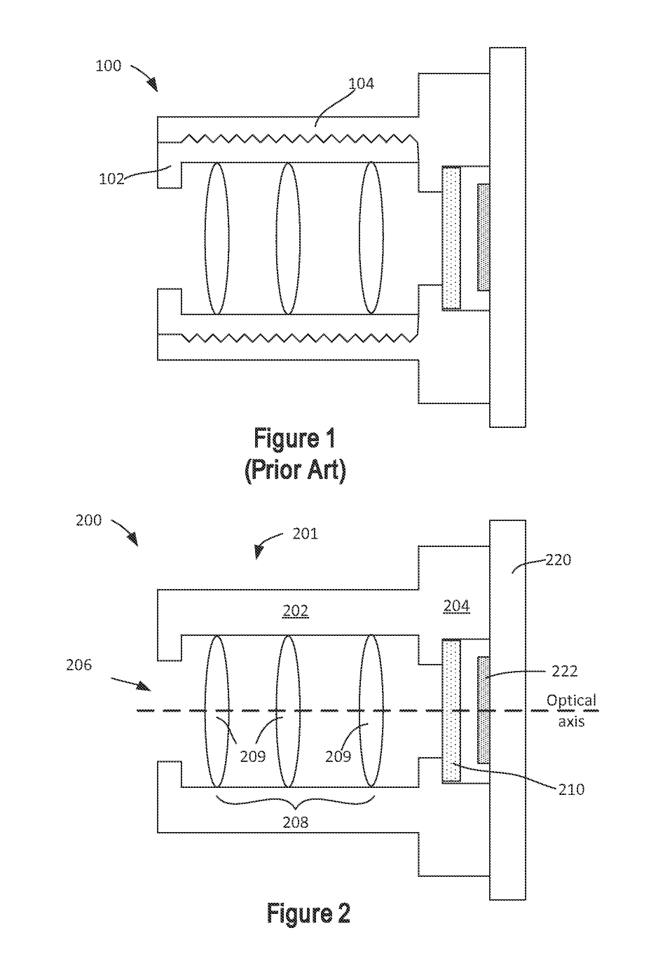

### DETAILED DESCRIPTION

The present invention relates to methods of manufacturing a compact camera module having a group of lens elements mounted in a housing unit and an image sensor arranged to provide a predetermined back focal length. The present invention also relates to a camera lens module having a barrel and a holder integrated in a single housing unit, in which one or more optical lens elements can be incorporated. The camera lens module can have broad applications in portable and wearable electronic devices, such as mobile phones, head mounted devices, tablet computers, and the like that use a CCD or a CMOS imaging sensor. Specific embodiments are described below. Those skilled in the art with access to the present disclosure will recognize that other camera lens modules can also be designed within the scope of the present invention.

FIG. 2 is a simplified cross-sectional view of a camera lens system 200 according to an embodiment of the present invention. Camera lens system 200 is shown as including a housing unit 201, in which a barrel 202 and a holder 204 are integrated. Housing unit 201 has an opening 206 to let light enter a lens group 208. Lens group 208 is mounted within barrel 202, which is the front portion of housing unit 201. Lens group 208 may include one or more lens elements 209. Housing unit 201 may also include an infrared cutoff filter 210 mounted along the optical axis. Camera lens system 200 also includes a substrate 220 and an image sensor 222 mounted on substrate 220. Housing unit 201 is attached to substrate 220 during manufacture.

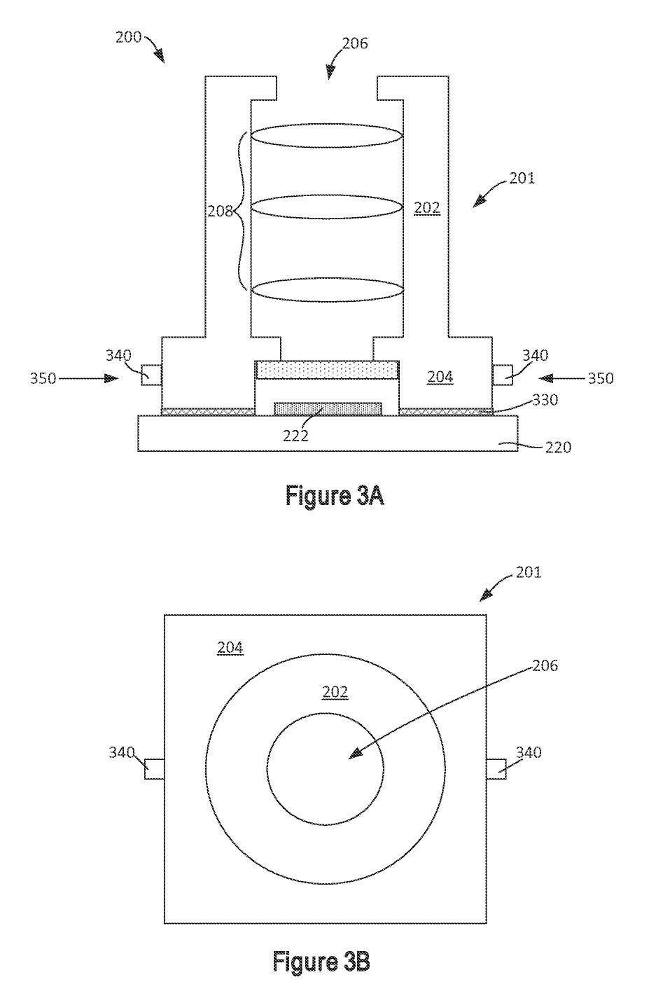

FIG. 3A is another cross-sectional view of camera lens system 200 illustrating that housing unit 201 can be coupled to substrate 220 with an adhesive 330. Lens barrel 202 can be cylindrical along the optical axis and is formed as an integral part of holder 204. Housing unit 201 may be formed by injection molding, where a material 350 (e.g., plastic) is injected to a mold through one or more gates 340. After cooling, housing unit 201 is removed from the mold.

FIG. 3B is a top view of housing unit 201 according to an embodiment of the present invention. In this embodiment, holder 204 has a square-shaped base. In other embodiments, the base of holder 204 may be circular, polygonal, oval or other shape. In this embodiment, the injection molding is performed through gates 340. While two gates 340 at opposite sides of housing unit 201 are shown, it is to be understood that the number and location of gates can be chosen as desired. For example, the number and location of gates can be so chosen such that a uniform thickness of the housing unit, the barrel or the holder can be obtained.

The position of housing unit 201 in relation to substrate 220 or to image sensor 222 affects the optical performance of a camera lens system. As shown in FIG. 2, camera lens system 200 may include several manufactured parts such as lens group 208, housing unit 201, image sensor 222, and substrate 220. Since the parts are typically manufactured using different tools, they may have different manufacturing tolerances. When the parts are assembled, the sum of tolerances may exceed the required tolerance of the lens system 200. Techniques for compensating for the manufacturing tolerances of the assembled parts can improve the quality and consistency of the assembled camera system.

One such technique involves disposing an adhesive member between the housing unit and the substrate of an optical imaging lens module to compensate for the manufacturing tolerances. Referring to FIG. 3A, the technique includes providing housing unit 201 including lens group 208 and substrate 220 including an image sensor 222. The position of housing unit 208 with respect to substrate 220 along the optical axis is then adjusted using a precision adjustment mechanism (not shown) so that an image is focused on image sensor 220. A gap (air gap, spacing) between housing unit 201 and substrate 220 is then filled with an adhesive 330 for securing adhesion (bonding) between housing unit 201 and substrate 220. Next, adhesive 330 is cured so that the gap (spacing) between housing unit 201 with substrate 220 is permanently maintained to obtain the target focal length or back focal length of the optical imaging lens module.

According to an embodiment, the method of manufacturing a compact optical imaging lens module may include providing a housing unit including a lens group, providing a substrate including an image sensor mounted thereon, and adjusting a gap (spacing) between the housing unit and the substrate to obtain a target effective focal length or back focal length. The method further includes inserting an adhesive member between the housing unit and the substrate to secure adhesion of the housing unit with the substrate and curing the adhesive member to permanently maintain the gap.

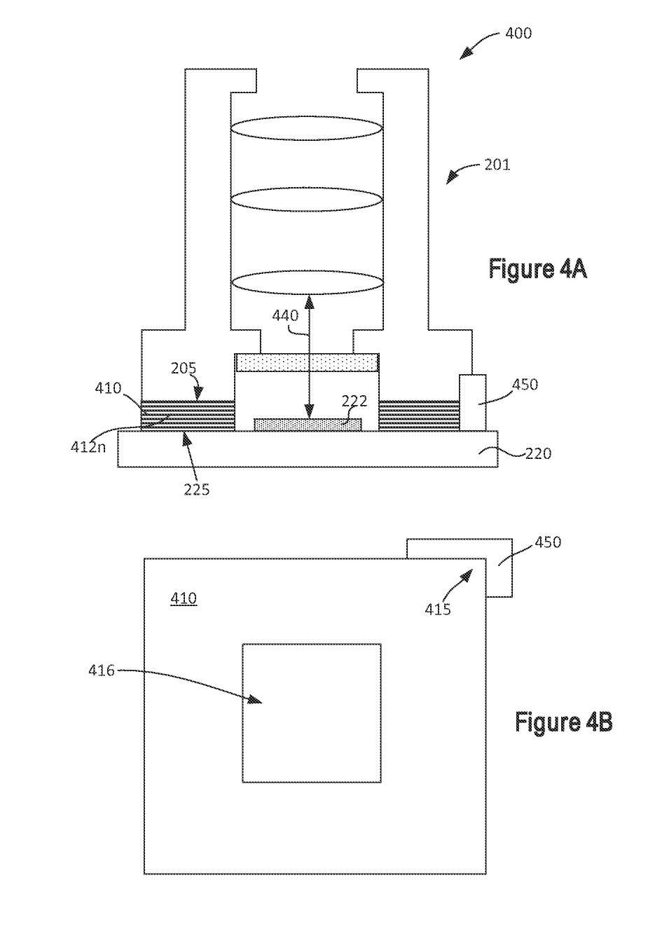

Another technique involves the use of one or more fitting members to adjust the spacing between the lenses and the image sensor. FIG. 4A shows a camera lens system 400 including a fitting member according to an embodiment of the present invention. In this embodiment, in order to adjust a back focal length 440 or an effective focal length of camera lens system 400, a fitting member 410 is inserted between a planar base 205 of housing unit 201 and a planar surface 225 of substrate 220. Back focal length 440 is defined as the distance between the image-side surface of the lens element nearest the image plane and the surface of image sensor 222.

In some embodiments, fitting member 410 may be made of one or more slices 412n, where n is an integer. In one embodiment, slices 412n may have the same thickness. In one embodiment, the thickness of each slices 412n may be equal to or less than 20 microns, preferably less than 10 microns, or more preferably less than 5 microns. The number of slices 412n can be selected to achieve a desired back focal length for a particular assembly, allowing compensation for manufacturing tolerances. For example, prior to inserting fitting member 410, the effective focal length or back focal length of the lens group can be measured, and the thickness (e.g., number of slices 412n) of fitting member 410 can be chosen accordingly.

In some embodiments, fitting member 410 and housing unit 201 can be aligned using a positioning member 450, which is mounted on the surface of substrate 220. FIG. 4B is a top view of a housing unit having a fitting member according to an embodiment of the present invention. In an embodiment, fitting member 410 may have a shape matching the shape of the planar base 205 of housing unit 201. In the example shown, fitting member 410 is square-shaped having an edge 415 abutted by positioning member 450, which can be an L-shaped structure. Fitting member 410 has an opening 416 that may be the same as or different from an opening of the planar base of housing unit 201. It is understood that positioning member 450 may have other shape that matches the contour of housing unit 201 and fitting member 410. For example, positioning member 450 can have a U-shape, a quarter-circular, or semi-circular shape to match corresponding contours of housing unit 201 and fitting member 410. Thus, by using a positioning member mounted on the surface of the substrate, it is possible to avoid a time consuming process of aligning the fitting member in relation to the housing unit.

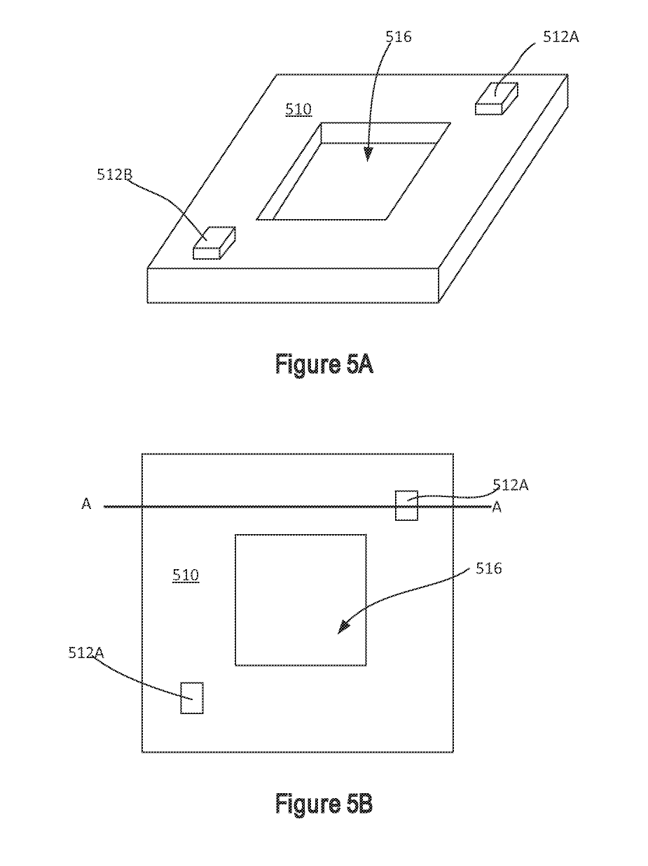

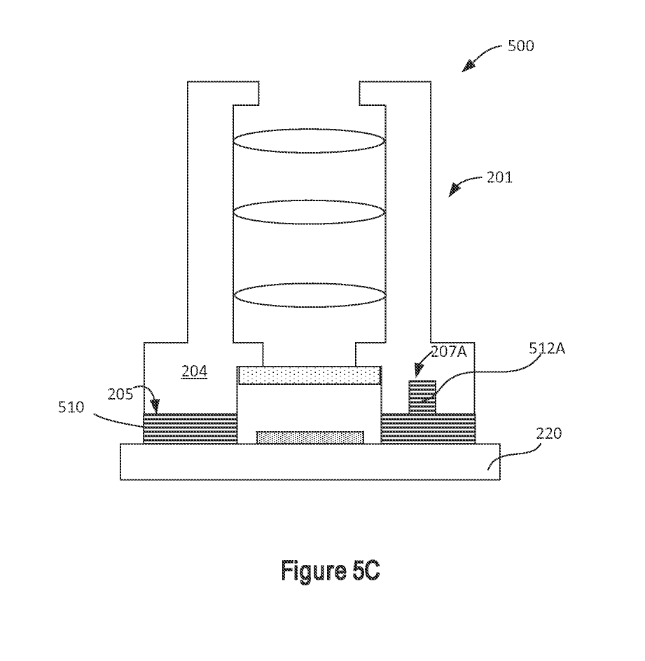

Another technique for aligning the components is shown in FIG. 5A, which is a perspective view of a fitting member 510 according to an embodiment of the present invention. As shown, fitting member 510 has protruding portions 512A, 512B that are disposed at diagonally opposite sides of an opening 516. Although protruding portions 512A, 512B are shown as having a square shape, it is understood that the shape of protruding portions 512A, 512B can be varied as desired. For example, each protruding portion 512A, 512B can have any other shapes such as circular, polygonal, oval shape, and any combination thereof. Further, more than two protruding portions (e.g., three, four or some other number) can be provided.

FIG. 5B is a top view of fitting member 510 of FIG. 5A. While fitting member 510 is shown having two protruding portions 512A, 512B disposed diagonally across opening 516, it is understood that fitting member 510 can have any number of protruding portions that are disposed anywhere on the surface of fitting member 510.

FIG. 5C is a simplified cross-sectional view of camera lens system 500 including a cross-sectional view of fitting member 510 of FIG. 5B cut along the line A-A. As shown, holder 204 has a recessed portion 207A configured to receive protruding portion 512A of fitting member 510. While only one recessed portion is shown in FIG. 5C, it is to be understood that a holder can have any number of recessed portions disposed at its planar base surface to receive the protruding portions of fitting member 510.

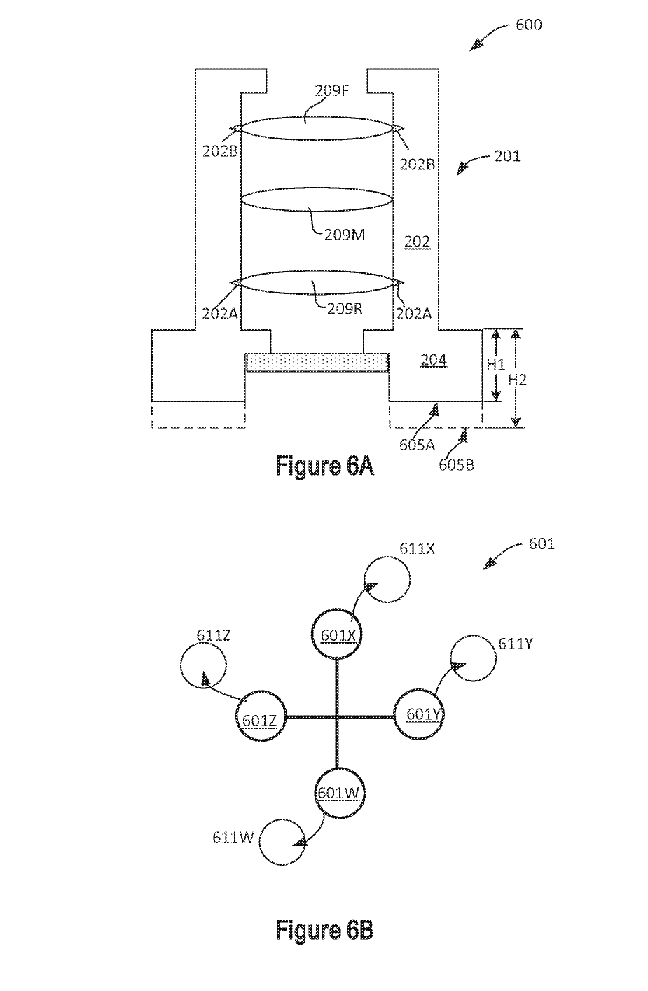

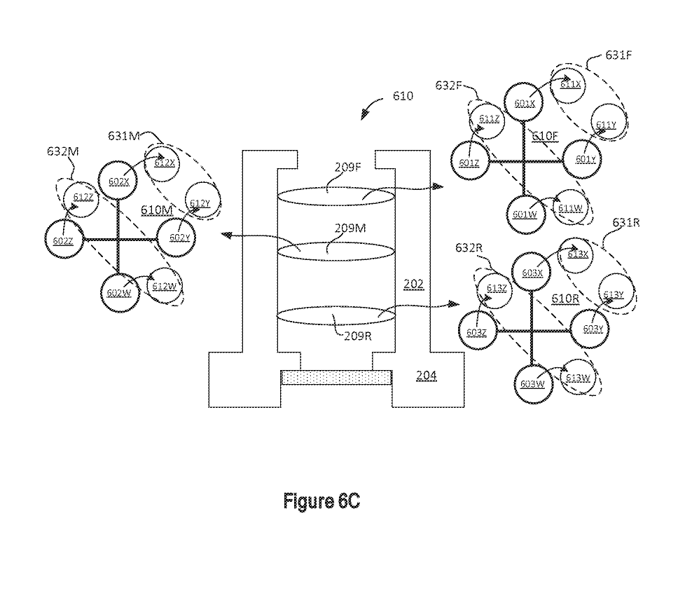

Another manufacturing technique provides compensation for tolerances of various parts by taking the tolerances into account when selecting parts for an assembly. FIG. 6A is a cross-sectional view of a camera lens system 600 according to an embodiment of the present invention. As shown, base portion 204 of housing unit 201 has a thickness (or height) that may vary from part to part due to tolerances. For instance, one part may have thickness H1 while another part has thickness H2. The thickness can be measured as the thickness of base portion 204 of housing unit 201 as shown. Alternatively, other measurements of thickness can be used. For example, in some embodiments, there can be a surface feature or other structure 202A on the inner surface of barrel 202 to receive and hold a rear-most lens element 209R of the lens group. Structure 202A may be, for instance, a notch, groove, or ledge, and height can be measured from the location of structure 202A to a rear surface 605A (or 605B) of housing unit 201. As another example, there can be a surface feature or other structure 202B on the inner surface of barrel 202 to receive and hold a front-most lens element 209F of the lens group. Structure 202B may be a notch, groove, or ledge, and the height can be measured from the location of structure 202B to rear surface 605A (or 605B). More generally, any measure of thickness that characterizes the position at which a lens group will be held, relative to the image sensor, by a particular housing unit can be used.

In some embodiments, manufactured lens groups can be sorted into bins based on the measured focal lengths, and housing units can also be sorted into bins based on measured thickness (or height). A lens group having a particular measured focal length can be matched with a housing unit having a measured thickness value, so that the sum of the focal length tolerance of the lens group and the thickness tolerance of the housing unit is within a desired specification. For example, a lens group that has a “too long” focal length (i.e., longer than a nominal specified value due to manufacturing tolerance) can be assembled within a housing unit having a corresponding “too thick” thickness (i.e., thicker than a nominal specified value due to manufacturing tolerance) so that the resulting optical lens assembly is within a desired optical specification. Likewise, a lens group having a “too short” focal length can be assembled within a housing unit having a “too thin” thickness to compensate for the short focal length.

In one example of a method of manufacturing a compact lens module, an injection mold is used to manufacture one or more lenses. For illustration purposes, assume first that the lens group consists of a single lens, which can be front-most lens 209F, or rear-most lens 209R, or any other lens. The single lens can be manufactured through injection molding using an injection mold having a number of lens-shaped cavities. FIG. 6B is a plan view of an injection mold 601 that can be used to make lenses according to an embodiment of the present invention. As shown, injection mold 601 includes lens-shaped cavities 601X, 601Y, 601W, and 601Z disposed evenly within injection mold 601. The cavities each are configured to provide lenses that have substantially the same physical size and optical characteristics. However, due to process variations and design constraints, lenses 611X, 611Y, 611W, and 611Z produced by respective cavities 601X, 601Y, 601W, and 601Z may have slightly different sizes and optical characteristics. Each of the lenses can be assembled in a reference housing unit (not shown) and one or more values of optical characteristics can be measured. The one or more optical characteristics can include, for example, a focal length, a back focal length, or a decentration. For purposes of illustration, assume that the measured values of the resulted assembly fall into two “classes,” with lenses 611X and 611Y being sorted into a first class having optical characteristic F1, and lenses 611W and 611Z being sorted into a second class having optical characteristic F2. As used herein, lenses or lens groups can be sorted into the same class if they have the same value of the measured optical characteristic(s) to within a tolerance budget. (There may be more or fewer classes, depending on the number of mold cavities and the variations between them, and the number of classes can be as large as or less than the number of mold cavities.)

Based on the obtained results, first and second housing units having first and second specific dimensions can be designed to accommodate the lenses in the first and second classes, such that each of the lenses of the first class when assembled with one of the first housing units will produce a lens assembly meeting a predetermined optical specification (such as the back focal length coinciding with the location of the plane where the image sensor will be located). Likewise, the assembly of any of the lenses in the second lens class with one of the second housing units will also produce a lens assembly meeting the same predetermined optical specification. This can be accomplished, for example, by selecting the thickness (or height) of the first and second housing units (e.g., H1 and H2 as shown in FIG. 6A) based on the optical characteristic of the first and second classes of lenses.

In some embodiments, the lens group may include multiple lenses, such as front-most lens 209F, middle lens 209M, and rear-most lens 209R, as shown in FIG. 6A. Each of these lenses can be manufactured through injection molding using an injection mold having a number of lens-shaped cavities. FIG. 6C shows plan views of the injection molds corresponding to the three lenses. As shown, front-most lens 209F may be one of lenses 611X, 611Y, 611W, and 611Z produced by respective cavities 601X, 601Y, 601W, and 601Z of injection mold 610F. Similarly, middle lens 209M may be one of lenses 612X, 612Y, 612W, and 612Z produced by respective cavities 602X, 602Y, 602W, and 602Z of injection mold 610M. Rear-most lens 209R may be one of lenses 613X, 613Y, 613W, and 613Z produced by respective cavities 603X, 603Y, 603W, and 603Z of injection mold 610R. The cavities each are configured to provide lenses having substantially the same physical size and optical characteristics. However, due to process variations and design constraints, lenses 611X, 611Y, 611W, and 611Z produced by respective cavities 601X, 601Y, 601W, and 601Z of injection mold 610F may have slightly different sizes and optical characteristics, and similarly for each of injection molds 610R. A lens group can be assembled in a reference housing unit by selecting one of front lenses 611X, 611Y, 611W, and 611Z, selecting one of middle lenses 612X, 612Y, 612W, and 612Z, and one of rear lenses 613X, 613Y, 613W, and 613Z. Once the lens group is assembled, one or more values of optical characteristics can be measured. The one or more optical characteristics can include a focal length, a back focal length, or a decentration. As in the single-lens example described above, due to process variations and design constraints, lenses produced from different cavities in the same injection mold may have slightly different optical characteristics. It follows that lens groups assembled from lenses produced from different sets of cavities (for instance a first lens group consisting of lenses 611X, 612X, and 613X and a second lens group consisting of lenses 611Z, 612Z, and 613Z) can have different optical attributes. In some embodiments, rather than assembling lens groups and measuring their attributes, optical characteristics of each lens can be individually measured and attributes of the resulting lens group can be predicted by computations from the measurements of individual lenses.

Similarly to the single-lens example, lens groups produced using injection molds 610F, 610M, 610R of FIG. 6C can be sorted into classes based on the measured (or predicted) optical attributes of each possible combination of lenses. For purposes of illustration, it is assumed that the selection of the molds for lenses to include together in a lens group assembly is not random. For example if lens 611X is selected as the front lens, then lens 612X is always selected as the middle lens, and lens 613X is always selected as the rear lens. Similarly, if lens 611Y is selected, then lenses 612Y and 613Y are also selected. This type of non-random selection conveniently reduces the number of combinations to be considered, but is not required. Optical attributes of each allowed combination of lenses, such as effective focal length or back focal length, can be determined (by measurement or prediction), and the lens groups can be sorted into classes based on their attributes. As in the single-lens example above, if lens groups from different injection molds have sufficiently similar values of their optical attributes (within a tolerance budget), they can be placed into a single class. Thus, there can be, for example, just two classes despite having four molds for each lens and three lenses in the lens group.

It is to be understood that injection molds 610F, 610M, and 610R with four cavities each are used as an example. Any number of cavities (p) may be used to produce the lenses for a particular position within a lens group, and a lens group can include any number (q) of lenses. Lens groups can be created by combining lenses from different molds in any manner desired, and there can be a large number of possible “different” lens group arrangements, e.g., up to q′ groups. The number of classes into which the lens groups are sorted can be equal to the number of lens groups, or smaller than the number of lens groups if different lens groups provide sufficiently similar (i.e., within a tolerance budget) optical characteristics.

In other embodiments, sorting the lenses into classes can be performed first at the level of individual lenses and then at the level of lens groups. For example, referring to FIG. 6C, front lenses 611X, 611Y, 611W, and 611Z can be sorted into classes based on measured optical characteristics, as described above for the single-lens case. Similarly, lenses 612X, 612Y, 612W, and 612Z can be sorted into classes, and lenses 613X, 613Y, 613Z, and 613W can also be sorted into classes. For purposes of assembling a lens group, lenses in the same class can be treated as having identical optical characteristics. The optical attributes of a lens group can be predicted based on the respective lens class of each of its constituent lenses, and the number of resulting lens group classes would be, for the three-lens example, C_{F}*C_{M}*C_{R}, where C_{F} is the number of classes of front lenses, C_{M} is the number of classes of middle lenses, and C_{R} is the number of classes of rear lenses. Depending on the number of lens positions and number of lens classes at each position, this sorting technique can further reduce the number of classes of lens groups.

Further reduction in the number of classes can also be obtained by making a non-random selection for the lens class at different positions. For example, referring to FIG. 6C, suppose that lenses 611X and 611Y are sorted together into class 631F while lenses 611W and 611Z are sorted together into class 632F as shown. Similarly, lenses 612X and 612Y are sorted together into class 631M while lenses 612W and 612Z are sorted together into class 632M as shown, and lenses 613X and 613Y are sorted together into class 631R while lenses 613W and 613Z are sorted together into class 632R. A non-random selection can be made such that if class 631F is selected, then class 631M and class 631R are also selected, and if class 632F is selected, then class 632M and class 632R are also selected. In this example, the number of classes is reduced to two.

According to some embodiments of the present invention, a number of housing units of the kind described above can be made by a molding process. The housing units each may be designed to have a dimension (e.g., thickness or height) such that, when a lens group belonging to one of the classes is assembled within the housing unit, a predetermined optical specification can be obtained. For example, if there are two classes of lens groups, two housing units may be designed to be different in a specific dimension to accommodate the different optical characteristics of the two classes of lens groups. For instance, the dimension can be the thickness or height of the holder, which can have a value of either H1 or H2, as shown in FIG. 6A. Thus, the housing units can also be provided in two (or more) classes. If there are more than two classes of lens groups, then an equal number of classes of housing units can be provided.

In the example above, a first mold of a first housing unit with height H1 can be made for manufacturing first housing units to accommodate lens groups in a class having optical attribute F1. A second mold of a second housing unit with height H2 can be made for manufacturing second housing units to accommodate lens groups having optical attribute F2. In some embodiments, the number of molds for the housing units can be the same as the empirically obtained number of lens-group classes. In other embodiments, the number of housing units molds can be fewer than the number of classes.

Methods of manufacturing optical assemblies according to an embodiment of the present invention will now be described with references to FIGS. 4A-4B, 5A-5B, and 6A-6C. For purposes of explanation, these methods are described with reference to the structures described previously. However, it should be understood that other structures could be used without departing from the scope of the present invention.

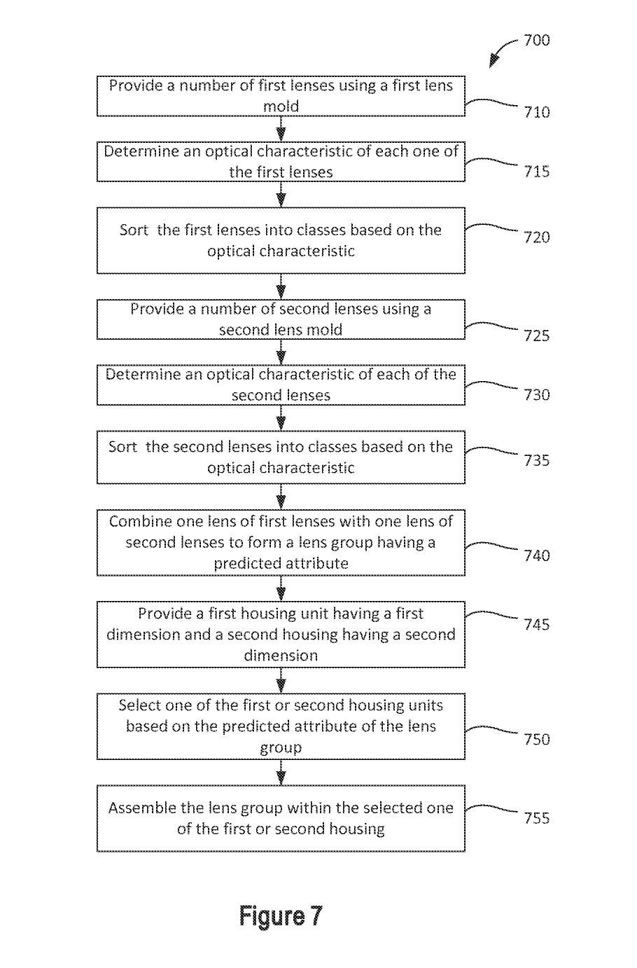

FIG. 7 is a flow chart illustrating a method 700 of manufacturing a compact optical lens module according to an embodiment of the present invention. At block 710, a number of first lenses is provided (e.g., lenses 611X, 611Y, 611W, 611Z described above). The first lenses may be provided using a first injection mold (e.g., mold 610F) having multiple identical lens-shaped cavities (e.g., cavities 601X, 601Y, 601W, 601Z). At block 715, an optical characteristic of each of the first lenses is measured. The optical characteristic can be, for example, a focal length or a back focal length. At block 720, the first lenses are sorted and grouped into classes having the same optical characteristic based on a tolerance range. At block 725, a number of second lenses is provided (e.g., lenses 612X, 612Y, 612W, 612Z described above) using a second injection mold (e.g., mold 612F) having multiple identical lens-shaped cavities (e.g., cavities 602X, 602Y, 602W, 602Z). Optical characteristics of the second lenses are measured at block 730, and the second lenses are sorted into classes according to their optical characteristics at block 735. At block 740, one of the first lenses and one of the second lenses are combined to form a lens group having a predicted attribute. At block 745, a first housing unit having a first measurement in a specific dimension (e.g., height or thickness H1) is provided, and a second housing unit having a second measurement in the same dimension (e.g., height or thickness H2) is provided. The dimensions can be chosen such that the combination of the first (second) housing unit and the first (second) lens group provides a predetermined optical specification, such as a back focal length that coincides with an image plane defined relative to the first (second) housing unit. At block 750, one of the first or second housing units is selected based on the predicted attribute of the lens group. At block 755, the lens group having the predicted attribute is assembled within the selected one of the first or second housing units.

In some embodiments, a variation of method 700 can be used in which a fitting member (e.g., fitting member 410 as described above) is optionally inserted to further adjust the spacing between the lens group and the image sensor to match a measured back focal length or effective focal length of the lens group. For instance, some lens groups may be outliers that do not provide the predetermined optical specification when combined with either the first or second housing unit, and a fitting member can be used to make further adjustments. As another example, a height or thickness difference between housing units made in the same mold can be obtained by inserting a fitting member; thus, in process 700, the first housing unit can be provided as a housing unit with a fitting member while the second housing unit can be provided as a housing unit without a fitting member.

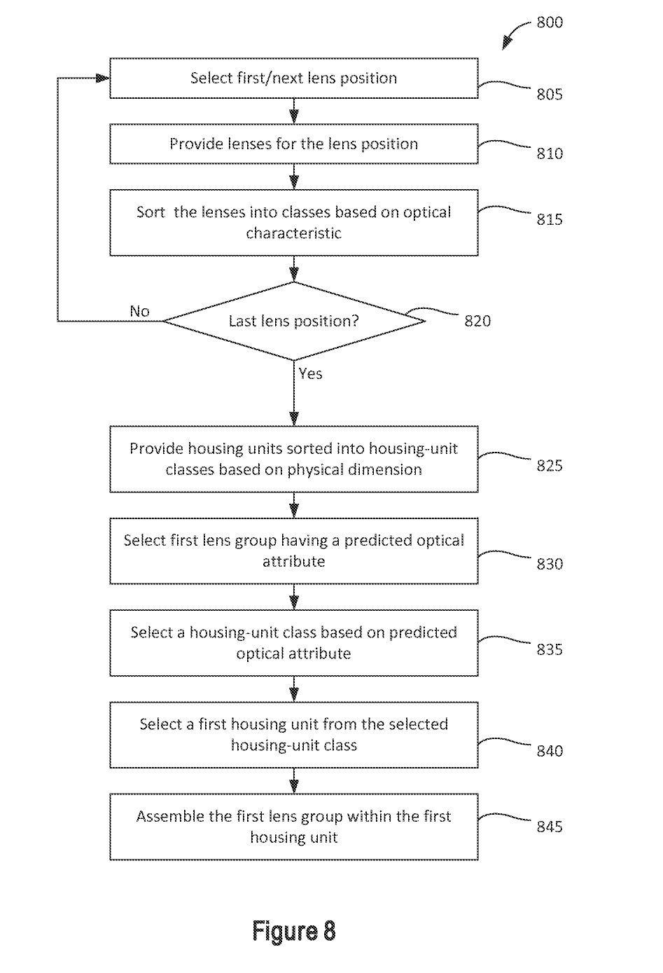

It should be noted that while method 700 is described with reference to a lens group with two lenses and two classes of housing units, this is done for simplicity of illustration. Embodiments of the invention can incorporate lens groups with any number of lenses and any number of different classes of housing units. FIG. 8 is a flow chart summarizing a method 800 of manufacturing a compact optical lens module with a lens group having an arbitrary number of lenses according to an embodiment of the present invention.

Method 800 can begin with sorting the lenses for each position in the lens group. Starting at block 805, the first lens position is selected. At block 810, lenses for this position are provided. For instance, the lenses can be manufactured using injection molding with multiple mold cavities designed to the same specification as described above. At block 815, the lenses are sorted into lens classes based on a measured optical characteristic. For instance, a sample of lenses from each mold cavity can be placed in a reference housing and optical characteristics such as focal lengths can be measured. At block 820, if the last lens position has not been reached, blocks 805-815 can be repeated for each lens position. At block 825, housing units can be provided. The housing units can be sorted into multiple housing-unit classes based on a physical dimension. For example, as described above, the physical dimension can be height or thickness of a holder or base portion of the housing unit. Further, as described above, housing units can be manufactured to have specific physical dimensions based on predicted attributes of lens groups.

At block 830, a first lens group can be selected. For example, a lens class can be selected for each lens position, and specific lenses for an assembly can be selected from the selected lens classes. The first lens group has a predicted optical attribute, which can be predicted based on the selected lens classes. For example, as described above, an optical attribute of a lens group such as back focal length or effective focal length can be predicted based on the measured optical characteristics (e.g., focal length) of the lenses (or lens classes) in the group. At block 835, a housing-unit class can be selected based on the predicted optical attribute of the first lens group, and at block 840, a first housing unit can be selected from the selected housing-unit class. At block 845, the first lens group can be assembled within the first housing unit. Blocks 830-845 can be repeated to produce any number of compact optical lens modules. As noted above, optical attributes for a lens group can be predicted on the basis of the combination of lens classes used for its constituent lenses. Accordingly, a mapping from a combination of lens classes to a housing-unit class can be defined and used during manufacture to allow for faster production.

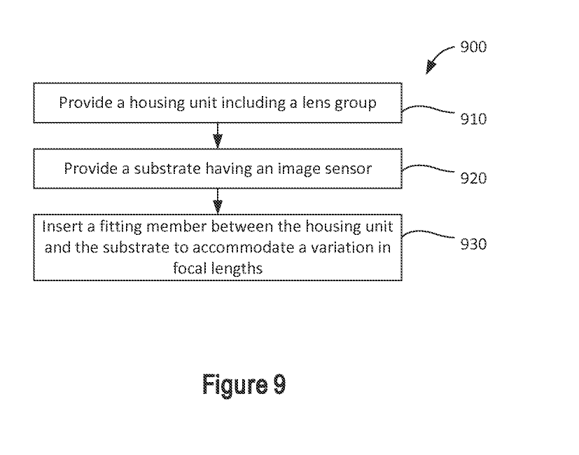

FIG. 9 is a flow chart summarizing another method 900 for manufacturing a compact optical lens module according to an embodiment of the present invention. At block 900, a housing unit including a lens group is provided. At block 920, a substrate having an image sensor mounted thereon is provided. At block 930, a fitting member is inserted between the housing unit and the substrate to accommodate a variation in focal lengths of the compact lens module.

While the invention has been described with reference to specific embodiments, it is to be understood that variations and modifications are possible. For example, the fitting member can include any number of slices, and the slices of different thicknesses and materials can be combined. The fitting member can have the same size or different size than the holder base. Thus, although the invention has been described with respect to specific embodiments, it will be appreciated that the invention is intended to cover all modifications and equivalents within the scope of the following claims.

What is claimed is:

1. A method of manufacturing a compact optical lens module, the method comprising:
providing a housing unit including a lens group;
providing a substrate including an image sensor; and
inserting at least one of a fitting member or an adhesive between the housing unit and the substrate to accommodate a variation in focal lengths of the compact optical lens module.

2. The method of claim 1, wherein inserting the fitting member comprises:
receiving a protruding portion of the fitting member within a recessed portion of the housing unit.

3. The method of claim 1, wherein inserting the fitting member comprises:
aligning the fitting member and the housing unit using a positioning member disposed on a surface of the substrate.

4. The method of claim 3, further comprising, prior to inserting the fitting member:
measuring an optical attribute of the lens group; and
selecting the fitting member based at least in part on the measurement.

5. The method of claim 4, wherein the optical attribute is a focal length.

6. The method of claim 1, wherein the lens group comprises one or more lens elements.

7. The method of claim 1, further comprising, prior to inserting the adhesive between the housing unit and the substrate:
adjusting a gap between the housing unit and the substrate to obtain a focus on the image sensor.

8. The method of claim 7, further comprising:
filling the gap with an adhesive for securing adhesion between the housing unit and the substrate; and
curing the adhesive to permanently maintain the gap.

9. A method of manufacturing a compact optical lens module, the method comprising:
providing a first plurality of lenses being produced by a first injection mold;
obtaining a first value of each of the first plurality of lenses;
sorting the first plurality of lenses into a first subgroups and a second subgroups in response to the obtained first value;
providing a second plurality of lenses being produced by a second injection mold;
obtaining a second value of each of the second plurality of lenses;
sorting the second plurality of lenses into a third subgroups and a fourth subgroups in response to the obtained second value;
combining one lens of the first plurality of lenses with one lens of the second plurality of lenses to form a lens group having a predicted attribute;
providing a first plurality of housing units having a first dimension and a second plurality of housing units having a second dimension; and
assembling the lens group within one of the first or second plurality of housing units based on the predicted attribute.

10. The method of claim 9, wherein the predicted attribute is a back focal length.

11. The method of claim 9, wherein the predicted attribute is an effective focal length.

12. The method of claim 9, wherein the first value or the second value is a focal length.

13. The method of claim 9, wherein the first injection or the second injection mold comprises a plurality of lens-shaped cavities having a substantially same size.

14. The method of claim 9, wherein obtaining the first or second value comprises:
placing the first or second lens into a reference housing unit; and
measuring a focal length of the first or second lens.

15. The method of claim 9, wherein the first or second dimension is a thickness of a holder of the housing unit.

16. A compact optical imaging lens module comprising:
a housing unit having a base;
a lens group disposed and held within the housing unit;
a substrate including an image sensor; and
at least one of a fitting member or an adhesive disposed between the base of the housing unit and a surface of the substrate.

17. The compact optical imaging lens module of claim 16, wherein the housing unit comprises at least two gates for injection molding.

18. The compact optical imaging lens module of claim 16, wherein the fitting member has an opening in relation to the image sensor so that light through the housing unit irradiates the image sensor.

19. The compact optical imaging lens module of claim 16, wherein the fitting member comprises a plurality of slices.

20. The compact optical imaging lens module of claim 19, wherein each of the slices has a same thickness.

21. The compact optical imaging lens module of claim 16, wherein the fitting member has a protruding portion and the base of the housing unit has a recessed portion, the recessed portion being configured to receive the protruding portion.

22. The compact optical imaging lens module of claim 16, wherein the fitting member has a plurality of protruding portions and the base of the housing unit has a plurality of recessed portions, each of the recessed portions being configured to receive a corresponding one of the protruding portions.

23. The compact optical imaging lens module of claim 16, further comprising a positioning member disposed on the surface of the substrate and configured to align the fitting member with the housing unit.
